(19) United States
(12) Patent Application Publication
(10) Pub. No.: US 2026/0238538 A1
(43) Pub. Date: Aug. 13, 2026

(54) GENERATING AN ORTHOGONAL TIME FREQUENCY DIVISION MULTIPLEXING WAVEFORM WITH CIRCULAR DELAY DIVERSITY IN TIME DOMAIN

(71) Applicant: WISIG NETWORKS PRIVATE LIMITED, Madinaguda, Hyderabad (IN)

(72) Inventors: Koteswara Rao Gudimitla, Srikalahasti (IN); Sibgath Ali Khan Makandar, Hyderabad (IN)

(21) Appl. No.: 19/475,152

(22) PCT Filed: May 5, 2024
(86) PCT No.: PCT/IN2024/050484

§ 371 Date: Oct. 14, 2025

(30) Foreign Application Priority Data
May 5, 2023 (IN) 202341032187

(51) Int. Cl. H04L 27/26

(52) U.S. Cl. CPC H04L 27/2636

(57) ABSTRACT

Embodiments of the present disclosure are related, in general to communication, but exclusively relate to methods and systems for generating orthogonal time frequency division multiplexing (OTFDM) waveform with circular transmit diversity in time domain. The method comprises time-multiplexing at least one data sequence with at least one RS, to generate a multiplexed sequence. Also, the method comprising obtaining a plurality of circularly shifted sequences using the multiplexed sequence. Each of the plurality of circularly shifted sequences is obtained by circularly shifting the multiplexed sequence by a predefined number of samples or multiples of predefined number of samples. Further, the method comprises generating an OTFDM symbol corresponding to each of the plurality of circularly shifted sequences. Thereafter, transmitting an OTFDM waveform, by mapping the generated OTFDM symbols to the corresponding antenna ports of the communication system.

### CROSS-REFERENCE TO RELATED APPLICATIONS

This application claims priority from the Indian Provisional Patent Application No. 202341032187 filed on May 5, 2023, the entirety of which are hereby incorporated by reference.

### TECHNICAL FIELD

Embodiments of the present disclosure are related, in general to communication, but exclusively relate to methods for generating and transmitting orthogonal time frequency division multiplexing (OTFDM) waveform with circular delay diversity in time domain.

### BACKGROUND

Orthogonal Frequency Division Multiplexing (OFDM) is widely used in telecommunication and Wireless Fidelity (Wi-Fi) systems. OFDM allows resourceful utilization of a bandwidth. OFDM involves creating sub-carriers from a wideband carrier. Each sub-carrier is an orthogonal frequency, and each sub-carrier carriers a sequence of data. The procedure of mapping data sequence to sub-carriers is known as sub-carrier mapping. The use of orthogonal frequencies helps in reducing guard bands, thus utilizing the bandwidth completely. Because of these advantages, OFDM has been used as a basic waveform for downlink in LTE, LTE advanced, and 5G-NR. However, OFDM use multiple sub-carriers, using OFDM for uplink leads to high Peak Power to Average Ratio (PAPR).

Higher the PAPR of the transmitter signal, higher will be the power backoff of the Power Amplifier (PA), which results in low power transmissions of Uplink signal. Hence, the cell range/radius will be compromised. Addressing the PAPR issue in OFDM, Discrete Fourier Transform (DFT) spread OFDM (DFT-s-OFDM) has been proposed and eventually used for transmitting data. Here, the data is first precoded by taking a DFT of allocation size before mapping the data to the allocated sub-carriers. The DFT-s-OFDM is essentially a single carrier modulation scheme. Hence, DFT-s-OFDM has lower PAPR compared to OFDM. Furthermore, DFT-s-OFDM has similar robustness to the frequency selective fading as OFDM as cyclic prefix is introduced to reduce Inter Symbol Interference (ISI).

To further reduce the PAPR of DFT-s-OFDM waveform, waveform-based solutions like Pi/2-BPSK modulation is used to modulate the user data. On the DFT precoded pi/2-BPSK symbols spectrum shaping filter is applied to reduce the PAPR further. Low PAPR allows the signal to be transmitted at higher transmitting power by reducing the PA power backoff. However, spectrum shaping along with DFT precoding may not show much effect on the PAPR of higher modulation schemes resulting in no improvement in increasing the transmit signal power.

In existing systems, a DFT-s-OFDM symbol comprises a data sequence or a pilot sequence (reference sequence). The reference sequence is necessary for enabling channel equalization. The data sequence and the reference sequence are time multiplexed and are sent as independent symbols, i.e., in one symbol data sequence is transmitted and, in another symbol, the reference sequence is transmitted. Hence, in every symbol reference signal may be present. However, in mm wave systems there is a need to track the phase variation caused by Oscillator drift within/on each OFDM symbol. When uplink transmitter employs DFT-S-OFDM there is need for a provision to enable phase tracking within one OFDM symbol or across OFDM symbols.

In systems like URLLC, which is one of the use cases in current 5G systems, requires very low latency communications. In current systems, data and reference signals are transmitted in different symbols. The channel is estimated on the reference signal, which eventually will be used for demodulation of the received user data. Hence, latency may be present because of transmission of reference signal and data in different symbols. Also, in systems where the user moves at high velocities such as in high-speed trains/satellites the propagation channel varies fast in time causing rapid variations in magnitude/phase of the channels. In such cases there needs to be a mechanism to enable channel magnitude/phase tracking. The waveform should also be constructed such that the overall signal has low peak-to-average ratio (PAPR) and enables operation of the power amplifier (PA) efficiency with low back-off.

3GPP (3rd Generation Partnership Project) has developed 5G-NR standards to support use cases like eMBB, URLLC, MMTC. It has been agreed to use CP-OFDM waveform and DFT-s-OFDM waveform for uplink transmission in 5G-NR. Here, CP-OFDM is mainly used for higher data rates, while, because of its low PAPR and high-power efficiency, DFT-s-OFDM is used to serve the cell edge UEs. Current 5G standards uses slot structure, where user data is transmitted in series of OFDM symbols. A typical slot structure comprises of one or more data symbols and one or more reference symbols.

6G Mobile Communication System requires a method of information transmission and that offers extremely low latency, very high data rate, and very high-power efficiency. DFT-S-OFDM waveform, which is power efficient and supports high data rates is well suitable for this purpose. However, to achieve extremely low latency, it is desirable to transmit the information (like user data, RS, and control information) in a single shot i.e., using a single OFDM symbol. However, conventional DFT-S-OFDM requires at least one data symbol and at least one reference symbol (RS). The RS is required for the purpose of estimating the channel state information (CSI) and subsequent equalization of data symbol. The current two-symbol structure in 5G-NR not only doubles the latency (compared to single symbol case), but also has a higher RS overhead i.e., 50%. There is a need for a new type of waveform that allows at least one-shot transmission with flexible RS overhead and high-power efficiency. Furthermore, transmission of control information requires appropriate spreading methods of control/data/RS for at least one-shot transmission waveform with high-power efficiency.

### SUMMARY

The shortcomings of the prior art are overcome and additional advantages are provided through the provision of method of the present disclosure.

Additional features and advantages are realized through the techniques of the present disclosure. Other embodiments and aspects of the disclosure are described in detail herein and are considered a part of the claimed disclosure.

In one aspect of the present disclosure a method for transmitting an OTFDM waveform with circular transmit diversity is disclosed. The method comprising time-multiplexing, by a communication system, at least one data sequence with at least one RS, to generate a multiplexed sequence. Also, the method comprising obtaining, by the communication system, a plurality of circularly shifted sequences using the multiplexed sequence, each of the plurality of circularly shifted sequences is obtained by circularly shifting the multiplexed sequence by a predefined number of samples or multiples of predefined number of samples. Further, the method comprises generating, by the communication system, an OTFDM symbol corresponding to each of the plurality of circularly shifted sequences and transmitting an OTFDM waveform, by mapping the generated OTFDM symbols to the corresponding antenna ports of the communication system.

In another aspect of the present disclosure a method for transmitting an OTFDM waveform with circular transmit diversity is provided. The method comprising generating, by a communication system, at least one data sequence and a plurality of reference sequences (RS). Also, the method comprises obtaining, by the communication system, a plurality of circularly shifted data sequences using the at least one data sequence, each of the plurality of circularly shifted data sequences is obtained by circularly shifting the at least one data sequence by a predefined number of samples or multiples of predefined number of samples. Further, the method comprises time-multiplexing, by the communication system, each of the plurality of circularly shifted data sequences with one of the plurality of RS to obtain a plurality of multiplexed sequences. Thereafter, the method comprises generating, by the communication system, an OTFDM symbol corresponding to each of the plurality of multiplexed sequences, and transmitting an OTFDM waveform, by mapping the generated OTFDM symbols to the corresponding antenna ports of the communication system.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE ACCOMPANYING DRAWINGS

The accompanying drawings, which are incorporated in and constitute a part of this disclosure, illustrate exemplary embodiments and, together with the description, serve to explain the disclosed principles. In the figures, the left-most digit(s) of a reference number identifies the figure in which the reference number first appears. The same numbers are used throughout the figures to reference like features and components. Some embodiments of device or system and/or methods in accordance with embodiments of the present subject matter are now described, by way of example only, and with reference to the accompanying figures, in which:

FIG. 1A shows an illustration of pre-discrete Fourier transform (DFT) symbol with RS pre-fix, RS, RS post-fix and data, in another embodiment of the present disclosure;

FIG. 1B shows an illustration of pre-DFT symbol with data CP, data, RS pre-fix, RS, and data, in another embodiment of the present disclosure;

FIGS. 1C-1D shows an illustration of pre-DFT symbols, in accordance with yet another embodiment of the present disclosure;

FIG. 2A shows a communication system for generating an orthogonal time frequency division multiplexing (OTFDM) waveform with circular time delay diversity in time domain, in accordance with an embodiment of the present disclosure;

FIG. 2B shows a block of orthogonal time frequency division multiplexing (OTFDM) symbol generation unit, in accordance with an embodiment of the present disclosure;

FIG. 3A shows an illustration of an OTFDM symbol with data RS CP, RS, data CP, and data;

FIG. 3B shows a block of a communication system for generating an OTFDM waveform with circular delay diversity in time domain, in another embodiment of the present disclosure;

FIG. 4 shows a block of a communication for transmitting an OTFDM waveform with circular transmit diversity, in another embodiment of the present disclosure; and

FIGS. 5A-5D show examples illustrating a circular shifting of the sequence and antennas for transmission, in accordance with an embodiment of the present disclosure.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether or not such computer or processor is explicitly shown.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the particular forms disclosed, but on the contrary, the disclosure is to cover all modifications, equivalents, and alternative falling within the spirit and the scope of the disclosure.

The terms “comprises”, “comprising”, or any other variations thereof, are intended to cover a non-exclusive inclusion, such that a setup, device or method that comprises a list of components or steps does not include only those components or steps but may include other components or steps not expressly listed or inherent to such setup or device or method. In other words, one or more elements in a device or system or apparatus proceeded by “comprises . . . a” does not, without more constraints, preclude the existence of other elements or additional elements in the device or system or apparatus.

The terms “an embodiment”, “embodiment”, “embodiments”, “the embodiment”, “the embodiments”, “one or more embodiments”, “some embodiments”, and “one embodiment” mean “one or more (but not all) embodiments of the invention(s)” unless expressly specified otherwise. The terms “including”, “comprising”, “having” and variations thereof mean “including but not limited to”, unless expressly specified otherwise. The enumerated listing of items does not imply that any or all of the items are mutually exclusive, unless expressly specified otherwise. The terms “a”, “an” and “the” mean “one or more”, unless expressly specified otherwise.

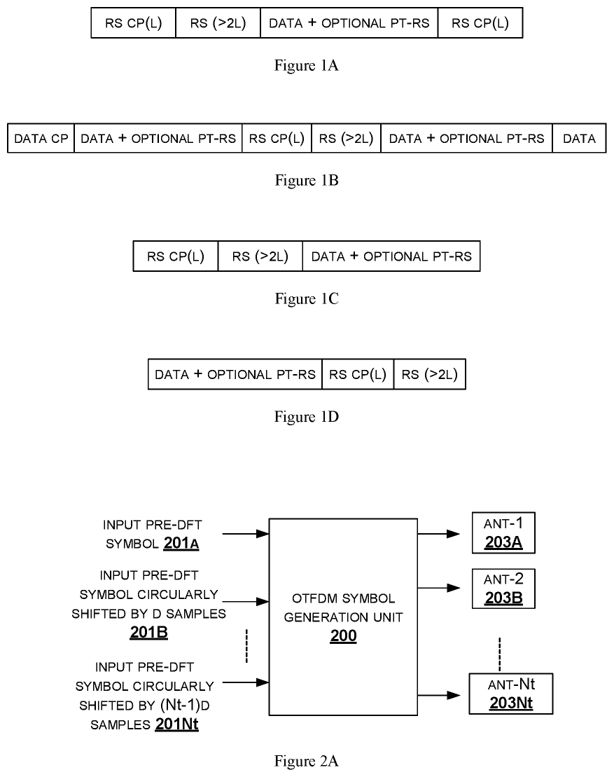

Embodiments of the present disclosure relate to generating an orthogonal time frequency division multiplexing (OTFDM) waveform using at least one of an input pre-DFT symbol and one or more input pre-DFT symbol circularly shifted by a predefined number of samples. In conventional OFDM systems, the RS and user data are transmitted in different OFDM symbols, such that channel estimation to equalize the data can be estimated clearly at the receiver, and CP is added to each symbol that results in excess overhead. The present disclosure a method for generating a waveform is disclosed. The method comprising generating at least one data sequence or at least one reference sequence (RS). Also, the method comprises time-multiplexing the data sequence with the RS to generate a multiplexed sequence. The time multiplexed sequence is referred as a pre-DFT symbol. The multiplexed sequence also includes at least one of RS cyclic prefix (CP), RS cyclic suffix/post fix (CS), data CP and optional phase tracking reference signal (PT-RS). The multiplexed sequence is as shown in FIGS. 1A and 1B.

FIGS. 1A and 1B shows orthogonal time frequency division multiplexing (OTFDM) symbol structures with data and RS. FIG. 1A shows an illustration of a symbol with RS pre-fix, RS, RS post-fix and data. FIG. 1B shows an illustration of a symbol with data CP, data, RS pre-fix, RS, and data. The one OFDM symbol length is M, comprising of data and RS. In an embodiment, the data may optionally include PT-RS for phase compensation at the receiver.

FIGS. 1C-1D shows an illustration of OTFDM symbols, in accordance with an alternative embodiments of the present disclosure.

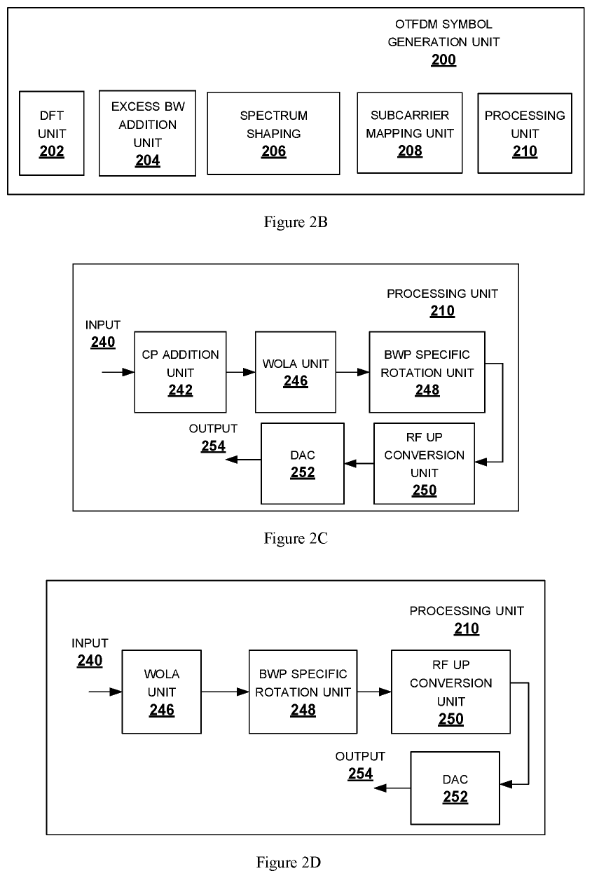

FIG. 2A shows a communication system for generating an orthogonal time frequency division multiplexing (OTFDM) waveform with circular time delay diversity in time domain, in accordance with an embodiment of the present disclosure. The communication system is referred to as a transmitter or a base station (BS). In another embodiment, the communication system is a user equipment (UE). As shown in FIG. 2A, the transmitter comprises an OTFDM symbol generation unit 200, a plurality of input pre-DFTs (201A, 201B, . . . 201Nt), and a plurality of antennas (203A, 203B, . . . 203Nt). The plurality of input pre-DFTs is also referred to as multiplexed sequences or a plurality of multiplexed sequences 201. The plurality of antennas are referred to as antennas 203.

The communication system comprises a pre-DFT generator generates a plurality of pre-DFT symbols or referred as a plurality of multiplexed sequences. The generated plurality of pre-DFT symbols are at least one of a pre-DFT symbol, a pre DFT symbol circularly shifted by D samples, a pre DFT symbol circularly shifted by 2D samples, till a pre DFT symbol circularly shifted by (M−1) D samples, where D is a variable which is function of the plurality of antennas. Also, D is antenna specific variable. The variable D is also referred to as a predefined number, which depends on at least one of a cell size, a modulation index, and antenna ports. These generated symbols are time multiplexed symbols, as shown in FIGS. 1A-1D.

The multiplexed sequences is fed to the OTFDM symbol generation unit 200, to generate a plurality of OTFDM symbols specific to a particular antenna. Each of the OTFDM symbol generated is transmitted by one of a specific antenna from the plurality of antennas, which is dependent on the variable D.

The multiplexed sequences are obtained by time multiplexing at least one data sequence with at least one RS. The at least one data sequence is one of a pi/2 binary phase shift keying (pi/2-BPSK) sequence, a BPSK sequence, a Quadrature Phase Shift Keying (QPSK) sequence, M-ary Quadrature Amplitude Modulation (QAM) sequence, and an M-ary Phase Shift Keying (PSK) sequence.

The at least one data sequence comprises at least one of a user data, a control information, system information, and paging messages. The user data, control information, system information, and paging messages is a modulated alphabet or sequences of modulated alphabets. The at least one data sequence is appended with a data cyclic prefix (CP), in an embodiment as shown in FIG. 1B. Also, the at least one data sequence may comprise a user data and at least one phase tracking reference sequence (PTRS).

In an embodiment, a spreading operation is performed on the at least one data sequence with a spread code to generate a spread data sequence. The spread data sequence is multiplexed with the at least one RS, in an embodiment of the present disclosure.

In an embodiment, a spreading operation is performed on each of the plurality of multiplexed sequences with a corresponding spread code to generate a plurality of spread multiplexed sequences. Thereafter, each of the plurality of spread multiplexed sequences is fed to the OTFDM symbol generation unit.

In an embodiment, each of the plurality of circularly shifted sequences is appended with at least one of a corresponding cyclic prefix (CP) and a corresponding cyclic suffix (CS).

The at least one RS is one of a pi/2 binary phase shift keying (pi/2-BPSK) sequence, a BPSK sequence, a Zadoff-Chu (ZC) sequence, a Quadrature Phase Shift Keying (QPSK) sequence, and a M-ary Phase Shift Keying (PSK) sequence. In an embodiment, the at least one RS is appended with at least one of a cyclic prefix (CP) and a cyclic suffix (CS). As shown in FIG. 1A, the RS is appended on both sides with CP.

FIG. 2B shows a block of orthogonal time frequency division multiplexing (OTFDM) symbol generation unit. The OTFDM symbol generation unit 200 is also referred to as OTFDM generation unit 200 or an excess bandwidth (BW) DFT-s-OFDM symbol generation unit or OTFDM generator. As shown in FIG. 2B, the OTFDM symbol generation unit 200 comprises a Discrete Fourier Transform (DFT) unit 202, an excess BW addition unit 204, a spectrum shaping unit 206, a sub-carrier mapping unit 208, and a processing unit 210.

The DFT 202 transforms an input multiplexed sequence using a Discrete Fourier Transform (DFT) to generate a transformed multiplexed sequence.

The excess BW extension unit 204 performs padding operation on the transformed multiplexed sequence i.e. prefixing the transformed multiplexed sequence with a first predefined number (N1) of subcarriers and post-fixing the transformed multiplexed sequence with a second predefined number (N2) of subcarriers to obtain an extended bandwidth transformed multiplexed sequence. The value of the N1 is at least zero, and value of the N2 is at least zero. The values of N1 and N2 may be same or different. The value of N1 and N2 may depend on the excess power that is sent by the transmitter.

The spectrum shaping unit 206, also referred as a shaping unit or a filter, performs shaping of the extended bandwidth transformed multiplexed sequence to obtain a shaped extended bandwidth transformed multiplexed sequence or shaped sequence. The filter used for the shaping operation on the extended bandwidth transformed multiplexed sequence is one of a Nyquist filter, square root raised cosine filter, a raised cosine filter, a hamming filter, a Hanning filter, a Kaiser filter, an oversampled GMSK filter and any filter that satisfies predefined spectrum characteristics.

The sub carrier mapping unit 208, also referred as a mapper or a sub carrier mapper or a mapping unit, performs subcarrier mapping on the shaped extended bandwidth transformed multiplexed sequence or shaped sequence with at least one of localized and distributed subcarriers to generate a mapped extended bandwidth transformed multiplexed sequence. In an embodiment, the distributed subcarrier mapping includes insertion of zeros in to the extended bandwidth transformed multiplexed sequence.

The processing unit 210 performing an Inverse Fast Fourier Transform (IFFT) using the IFFT unit on the shaped extended bandwidth transformed multiplexed sequence to produce a time domain sequence and processing the time domain sequence to generate the OTFDM symbol. The OTFDM symbol may be referred as a filtered-extended bandwidth DFT-s-OFDM symbol. In an embodiment, the OTFDM symbol generation unit comprises the IFFT unit (not shown in the figure). In another embodiment, the processing unit 210 comprises the IFFT unit (not shown in the figure).

FIG. 2C shows a block diagram illustration of the processing unit of the OTFDM symbol generation unit. As shown in the FIG. 2C, the processing unit 210 comprises a cyclic prefix (CP) addition unit 242, a weighted with overlap and add operation (WOLA) unit 246, bandwidth parts (BWP) rotation unit 248, a radio frequency (RF) conversion unit 250 and a digital to analog converter 252.

The processing unit 210 processing of the time domain sequence 240 to generate an OTFDM symbol 254. For this, the processing unit performs at least one of a symbol specific phase compensation, an addition of symbol cyclic prefix or addition of symbol cyclic suffix using the CP addition unit 242, windowing or weighted with overlap and add operation (WOLA) operation using the WOLA unit 246, a BWP rotation using the BWP rotation unit 248, an additional time domain filtering, sampling rate conversion using RF up conversion unit to match DAC rate, frequency shifting on the time domain waveform and digital to analog conversion using DAC 252, to generate the OTFDM symbol or also referred to as filtered-extended bandwidth DFT-s-OFDM symbol. The OTFDM symbol generation unit generates a plurality of OTFDM symbols corresponding to the inputs i.e. plurality of pre-DFT symbols or plurality of multiplexed symbols or sequences. Thereafter, the communication system transmits an OTFDM waveform by mapping the generated OTFDM symbols to the corresponding antenna ports of the communication system. The generated OTFDM waveform which eventually offers low PAPR.

In an embodiment, the generated OTFDM symbols transmission is performed in a single shot transmission comprising at least one RS sequence, and at least one of data and control sequence and the said RS sequence is used to demodulate the said data or control sequence.

FIG. 2D shows a block diagram illustration of the processing unit of the OTFDM symbol generation unit, in accordance with another embodiment of the present disclosure. As shown in the FIG. 2D, the processing unit 210A comprises a weighted with overlap and add operation (WOLA) unit 246, bandwidth parts (BWP) rotation unit 248, a radio frequency (RF) conversion unit 250 and a digital to analog converter 252.

The processing unit 210 processing of the time domain sequence 240 to generate an OTFDM symbol 254. The time domain sequence is obtained for the IFFT unit, which is configured in the OTFDM symbol generation unit, in an embodiment. The input to OTFDM symbol generation is a plurality of multiplexed sequences or pre-DFT sequences as shown in FIG. 1C or FIG. 1D.

As shown in FIG. 2D, the processing unit performs at least one of a windowing or weighted with overlap and add operation (WOLA) operation using the WOLA unit 246, a BWP rotation using the BWP rotation unit 248, an additional time domain filtering, sampling rate conversion using RF up conversion unit to match DAC rate, frequency shifting on the time domain waveform and digital to analog conversion using DAC 252, to generate the OTFDM symbol. The OTFDM symbol generation unit generates a plurality of OTFDM symbols corresponding to the inputs i.e. plurality of pre-DFT symbols or plurality of multiplexed symbols or sequences. Thereafter, the communication system transmits an OTFDM waveform by mapping the generated OTFDM symbols to the corresponding antenna ports of the communication system. The generated OTFDM waveform which eventually offers low PAPR.

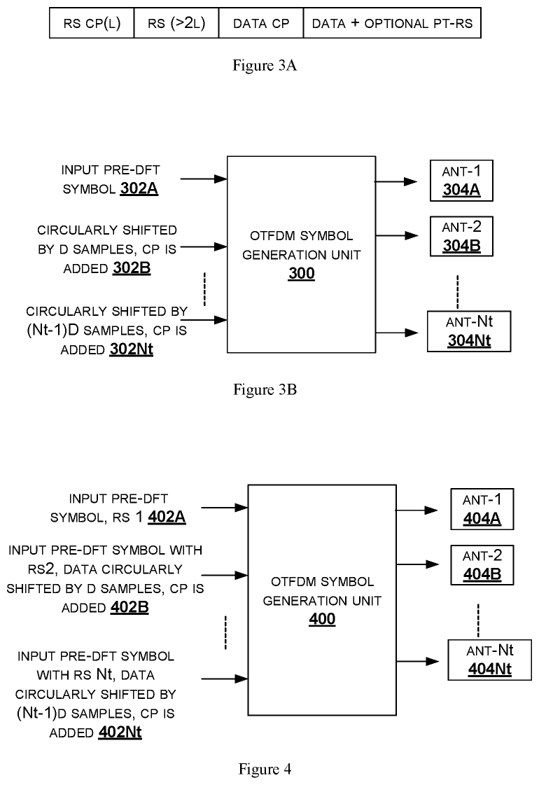

FIG. 3A shows an illustration of a OTFDM symbol with data RS CP, RS, data CP, and data. FIG. 3B shows a block of a communication system for generating OTFDM waveform with circular delay diversity in time domain, in another embodiment of the present disclosure.

The communication system is also referred to as a transmitter or a base station (BS), or gNB. In an embodiment the communication system is a user equipment (UE). As shown in the FIG. 3B, the transmitter comprises an OTFDM symbol generation unit, also referred to as an excess bandwidth DFT-s-OFDM symbol generation unit, input pre-DFT generator (not shown in the figure), and a plurality of antennas. The input pre-DFT generator, also referred as input pre-DFT generation unit or input generator, generates a plurality of pre-DFT symbols. The input is at least one of a pre DFT symbol, a pre DFT symbol circularly shifted by D samples followed by cyclic prefix (CP) addition, till a pre DFT symbol circularly shifted by (Nt−1) D samples followed by CP addition. The D is a variable which is function of the plurality of antennas. Also, D is antenna specific variable. The number of plurality of antennas is Nt, an integer. These generated symbols are time multiplexed symbols, as shown in FIG. 3A.

The multiplexed sequence is fed to the OTFDM symbol generation unit or excess bandwidth (BW) DFT-s-OFDM symbol generation unit, to generate a plurality of OTFDM symbols or a plurality of excess BW symbols specific to a particular antenna. Each of the symbols generated is transmitted by one of a specific antenna from the plurality of antennas, which is dependent on the variable D.

As shown in FIG. 3B, the transmitter comprises an OTFDM symbol generation unit 300, input pre-DFTs (302A, 302B, . . . 302Nt), and a plurality of antennas (304A, 304B, . . . 304Nt). The OTFDM symbol generation unit is as shown in FIG. 2B for the generation of the OTFDM waveform.

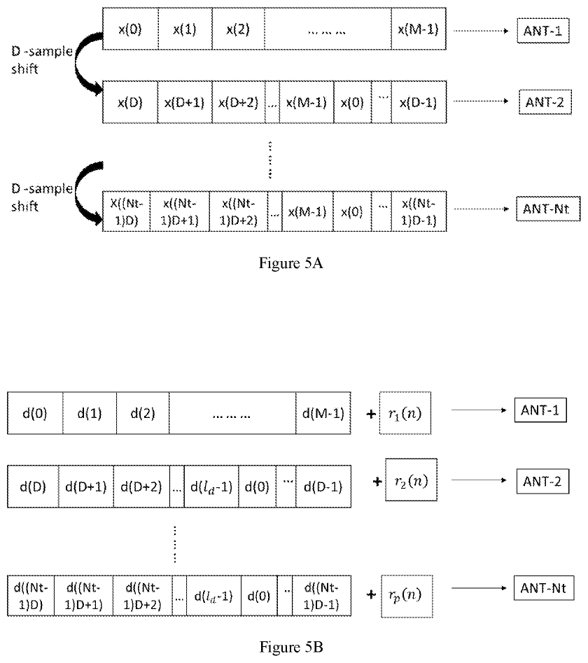

FIG. 4 shows a block of a communication for transmitting an OTFDM waveform with circular transmit diversity, in another embodiment of the present disclosure. The communication system is referred to as a transmitter or a base station (BS). In another embodiment, the communication system is a user equipment (UE). As shown in FIG. 4, the transmitter comprises an OTFDM symbol generation unit 400, a plurality of input pre-DFTs (402A, 402B, . . . 402Nt), and a plurality of antennas (404A, 404B, . . . 404Nt). The plurality of input pre-DFTs is also referred to as multiplexed sequences or a plurality of multiplexed sequences 402. The plurality of antennas are referred to as antennas 404.

As shown in FIG. 4, the communication system comprises an OTFDM symbol generation unit 400, an input pre-DFT generator, and a plurality of antennas 404. The OTFDM symbol generation unit 400 is also referred to as an excess bandwidth DFT-s-OFDM symbol generation unit.

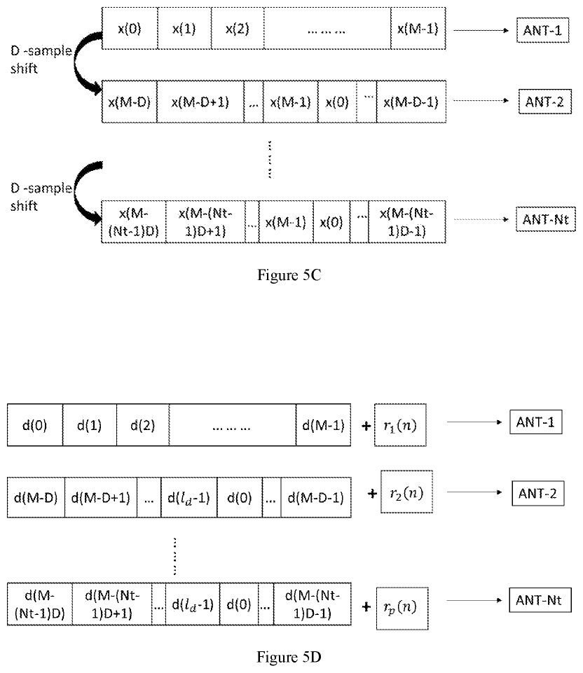

The communication system comprises a pre-DFT generator generates a plurality of pre-DFT symbols or referred as a plurality of multiplexed sequences. The input comprises at least one of a pre DFT symbol with RS1 (first RS), a pre DFT symbol with RS2 (second RS) circularly shifted by D samples followed by cyclic prefix (CP) addition, till a pre DFT symbol with RS (Nt) (RS of Nt-th count) with circular shift by (Nt−1) D samples. Each of the input is appended with a cyclic prefix. The D is a variable which is function of the plurality of antennas. Also, D is antenna specific variable. The number of plurality of antennas is Nt, an integer. These generated symbols are time multiplexed symbols, as shown in FIG. 3A and FIGS. 5A-5D.

The pre-DFT generator generates at least one data sequence and a plurality of reference sequences (RS). Next, it obtains a plurality of circularly shifted data sequences using the at least one data sequence i.e. each of the plurality of circularly shifted data sequences is obtained by circularly shifting the at least one data sequence by a predefined number of samples or multiples of predefined number of samples. The time multiplexing is performed on the each of the plurality of circularly shifted data sequences with corresponding RS from the plurality of RS to obtain a plurality of multiplexed sequences.

The multiplexed sequences is fed to the OTFDM symbol generation unit 400, to generate a plurality of OTFDM symbols specific to a particular antenna, using the multiplexed sequences. An OTFDM waveform is generated by mapping the generated OTFDM symbols to the corresponding antenna ports of the communication system.

The multiplexed sequences are obtained by time multiplexing at least one data sequence with at least one RS. The at least one data sequence is one of a pi/2 binary phase shift keying (pi/2-BPSK) sequence, a BPSK sequence, a Quadrature Phase Shift Keying (QPSK) sequence, M-ary Quadrature Amplitude Modulation (QAM) sequence, and an M-ary Phase Shift Keying (PSK) sequence.

The at least one data sequence comprises at least one of a user data, a control information, system information, and paging messages. The user data, control information, system information, and paging messages is a modulated alphabet or sequences of modulated alphabets. The at least one data sequence is appended with a data cyclic prefix (CP), in an embodiment. Also, the at least one data sequence may comprise a user data and at least one phase tracking reference sequence (PTRS).

In an embodiment, a spreading operation is performed on the at least one data sequence with a spread code to generate a spread data sequence. The spread data sequence is multiplexed with the at least one RS, in an embodiment of the present disclosure.

In an embodiment, a spreading operation is performed on each of the plurality of multiplexed sequences with a corresponding spread code to generate a plurality of spread multiplexed sequences. Thereafter, each of the plurality of spread multiplexed sequences is fed to the OTFDM symbol generation unit.

In an embodiment, each of the plurality of circularly shifted sequences is appended with at least one of a corresponding cyclic prefix (CP) and a corresponding cyclic suffix (CS).

The at least one RS is one of a pi/2 binary phase shift keying (pi/2-BPSK) sequence, a BPSK sequence, a Zadoff-Chu (ZC) sequence, a Quadrature Phase Shift Keying (QPSK) sequence, and a M-ary Phase Shift Keying (PSK) sequence. In an embodiment, the at least one RS is appended with at least one of a cyclic prefix (CP) and a cyclic suffix (CS). As shown in FIG. 1A, the RS is appended on both sides with CP. Each of the plurality of RS is different from each other, in an embodiment.

In an embodiment, each of the plurality of RS is generated by circularly shifting a base sequence with a predefined number of samples or multiples of predefined number of samples, said base sequence is one of a pi/2 binary phase shift keying (pi/2-BPSK) sequence, a BPSK sequence, a Quadrature Phase Shift Keying (QPSK) sequence, M-ary Quadrature Amplitude Modulation (QAM) sequence, and an M-ary Phase Shift Keying (PSK) sequence.

Each of the plurality of RS is multiplied with one or more transmitter specific code covers to obtain one or more transmitter specific RS. The each of the one or more transmitter specific code covers is one of a binary phase shift keying (BPSK) sequence, a Walsh Hadamard sequence, PN sequences, a DFT sequence, and a phase ramp sequence. Each of the plurality of RS sequence is obtained from same or different base sequences, in an embodiment.

The one or more transmitter specific RS is obtained by applying one or more transmitter specific cover codes on the at least one RS. In an embodiment, each of the one or more transmitter specific RS are orthogonal to each other in at least one of time, frequency, and code. Also, the one or more transmitter specific RS is appended with at least one of a transmitter specific RS CP and a transmitter specific RS CS in an embodiment.

Each of the one or more transmitter specific code cover is based on at least one of a transmitter specific RS antenna port, scrambling ID, symbol ID, slot number, and cell ID. In an embodiment, each of the one or more transmitter specific code covers are orthogonal to each other. The one or more transmitters are one of a plurality of antennas of a user, and one or more users, said each of the one or more users comprises one or more antennas.

In an embodiment, a cyclic shifting operation is performed by the OTFDM symbol generation unit 400 on each of the plurality of RS, wherein the cyclic shifted RS is appended with at least one of a cyclic shifted RS CP prefix and a cyclic shifted RS suffix. Each of the plurality of RS comprises at least one transmitter specific RS, at least one of a RS cyclic prefix (CP) and a RS cyclic suffix (CS). Also, each of the plurality of circularly shifted data sequences is appended with at least one of a corresponding cyclic prefix and a corresponding cyclic suffix in an embodiment. In an embodiment, each of the plurality of multiplexed sequences is appended with at least one of a corresponding CP and a corresponding CS.

The OTFDM symbol generating unit 400 as shown in the FIG. 4, is same as the OTFDM symbol generating unit as shown in FIG. 2B, which generates the OTFDM waveform.

FIGS. 5A-5D show examples illustrating a circular shifting of the sequence and antennas for transmission, in accordance with an embodiment of the present disclosure.

FIG. 5A shows an illustration of generating multiplexed sequences corresponding to the p antennas. The antennas are also referred to as transmit antennas. As shown in FIG. 5A, there are p multiplexed sequence corresponding to p-transmit antennas. Each antenna is having a corresponding multiplexed sequence which is a D sample left shift of the previous multiplexed sequence. For example, the antenna-1 represented as ANT-1 is associated with the sequence-1 or referred as multiplexed sequence-1. The antenna-2 (ANT-2) is associated with the multiplexed sequence-2 which is obtained by left shifting the multiplexed sequence-1 by D samples. The next sequence associated with ANT-3 is obtained by left shifting the multiplexed sequence-2 by D samples. Similarly, for all the other antennas till Nt th antenna.

FIG. 5B shows an illustration of generating multiplexed sequences corresponding to the p antennas. Each multiplexed sequences associated with each of the plurality of antennas is obtained in the same manner as shown the FIG. 5A, and appending each multiplexed sequence with antennas specific RS.

FIG. 5C shows another illustration of generating multiplexed sequences corresponding to the p antennas. As shown in FIG. 5C, there are Nt multiplexed sequence corresponding to Nt-transmit antennas. Each antenna is having a corresponding multiplexed sequence which is a D sample right shift of the previous multiplexed sequence. For example, the antenna-1 represented as ANT-1 is associated with the sequence-1 or referred as multiplexed sequence-1. The antenna-2 (ANT-2) is associated with the multiplexed sequence-2 which is obtained by right shifting the multiplexed sequence-1 by D samples. The next sequence associated with ANT-3 is obtained by right shifting the multiplexed sequence-2 by D samples. Similarly, for all the other antennas till Nt th antenna.

FIG. 5D shows yet another illustration of generating multiplexed sequences corresponding to the Nt antennas. Each multiplexed sequences associated with each of the plurality of antennas is obtained in the same manner as shown the FIG. 5Cs, and appending each multiplexed sequence with antennas specific RS.

In an embodiment of the present disclosure a method to address latency and power efficiency of a DFT-s-OFDM waveform is provided using OTFDM, that is by multiplexing RS and data in one OFDM symbol with its own cyclic prefix and suffix. The data and RS are multiplexed, before DFT precoding, by adding either cyclic prefix or suffix or both cyclic prefix and suffix to the multiplexed data. The position of RS can be in the center or starting or ending of the OFDM symbol. The sequence to be used as RS can be pi/2-BPSK, QPSK, or ZC sequences, or M-PSK sequences. QPSK, pi/2-BPSK sequences may be generated using the binary sequences from Walsh codes, or, m-sequences, Kasami sequences, Gold sequences, or may be obtained from the pre-defined sequences. The generation of these sequences for RS may depend on the cell/sector/Base station ID, scrambling ID, symbol number, subframe number corresponding to the frame and the numerology. ZC sequences generation is defined as

$$r ( n ) = {e}^{\frac{j u n ( n + 1 + 2 q )}{{N}_{ZC}}} ; n = \{ 0 , 1 , 2 , … {N}_{ZC} - 1 \} \\ {N}_{Z C} is the length of the sequence that needs to be generated .$$

The RS sequence obtained using ZC can be a plain ZC sequence or cyclically extended ZC sequence. To support better channel estimation either pre-fix or post-fix or both pre-fix and post-fix will be added to the RS in the time domain. The mentioned pre-fix or post-fix may have at least one sample of the mentioned sequences. The Frequency spectrum of RS could be flat to ensure unbiased channel estimation. RS and CP for RS can occupy a portion of resources allocated to the user, which may depend on properties of channel conditions, Excess bandwidth, user allocation size, modulation order, coding rate, and other parameters like impulse response of spectrum shaping filter.

In another embodiment, a multiple RS chunks may be used while multiplexing RS with data. One possible way is to keep more than one chunk of RS samples with each chunk having same number of samples. Here, RS in each chunk can be the same sequence or different sequence. And all the chunks will either have both pre-fix and post-fix or post-fix or pre-fix. Each chunk may be used for channel estimation and the user data adjacent to the chunk will be equalized with the channel that is estimated. This kind of design helps in tracking the high Doppler channel, which may vary within an OFDM symbol.

In another embodiment, the size of each RS chunk can be different. Here, size of at least one RS chunk may be larger, while the sizes of one or more other chunks may be small in size with at least one sample. The longest RS chunk will have pre-fix or post-fix or both pre-fix and post-fix and may be used for channel estimation, while the smaller RS chunks may be used for phase tracking with in the OFDM symbol. The density of smaller RS chunks and number of smaller RS chunks may depend on phase noise estimation accuracy. The CP and CS added to the time multiplexed symbol corresponds to the long RS chunk.

The user data contains pi/2-BPSK, QPSK, QAM, or PAM modulation symbols. Data can be either related to control messages like ACK/NACK, CQI or user specific information. The data may or may not be appended with either cyclic prefix or suffix or both cyclic prefix and suffix. As discussed earlier, in the proposed system the data and RS are time multiplexed. The time multiplexed RS and data may be appended with either prefix or suffix or both depending on the presence of pre-fix and suffix for RS, such that the entire symbol may become circular. The pre-fix and suffix added to the multiplexed RS-data depends on the position of RS. For example, as shown in FIGS. 1A and 1B, RS with pre-fix and post-fix is located at the beginning of the symbol, and the multiplexed symbol having cyclic prefix and suffix as the RS cyclic prefix and suffix. The multiplexed symbol with prefix and suffix can be represented by x′(n), where n=0, 1, . . . , M−1. DFT precoding is applied on the resultant multiplexed symbol through an M sized DFT.

$$X ( k ) = \frac{1}{\sqrt{M}} {\sum }_{n = 0}^{M - 1} {x}^{′} ( n ) {e}^{- \frac{j 2 π}{M}} ; k = \{ 0 , 1 , 2 , 3 , … M - 1 \} ; j = \sqrt{- 1}$$

In one embodiment, the input data is a plurality of real or complex-valued symbols. in an embodiment a spread code sequence is applied on each symbol. The spread sequence may be selected as one of BPSK, Gold sequences, m-sequences etc. The RS may use ZC sequences or BPSK sequences where BPSK sequences or spreading codes may be obtained from Gold sequences, m-sequences or computer-generated sequences that minimize PAPR. In another embodiment, data of multiple users is multiplexed using at least one of time, frequency and code domain using DFT-S-OFDM that uses pi/2 BPSK modulation with spectrum shaping or higher order modulation. In this embodiment, RS is time multiplexed with data or RS may occupy different OFDM symbols other than data. The RS of multiple users may be multiplexed in at least one of time, code, and frequency dimensions.

The user data may contain pi/2-BPSK, QPSK, QAM, or PAM modulation symbols. Data can be either related to control messages like ACK/NACK, CQI or user specific information. Spreading is applied on data or control information. The data and RS are time multiplexed. For example, in the FIG. 1, RS with pre-fix and post-fix is located at the centre of the symbol, while the spreaded control/data occupies the starting and end positions of the symbol. The multiplexed symbol can be represented by x′(n), where n=0, 1, . . . , M−1. DFT precoding is applied on the resultant multiplexed symbol through an M sized DFT.

$$X ( k ) = \frac{1}{\sqrt{M}} {\sum }_{t = 0}^{M - 1} {x}^{′} ( n ) {e}^{- \frac{j 2 π k n}{M}}$$

It is to be noted that, to maintain the PAPR, when the user data is pi/2-BPSK modulated, then pi/2-BPSK based reference sequences has to be used, so that phase continuity is maintained between the RS and user pi/2-BPSK data. Spectrum extension is performed on the DFT pre-coded symbol, where, last d/2 samples of the pre-coded data are copied and placed at the beginning of the symbol as pre-fix and then the initial d/2 samples of the pre-coded data are copied and placed at the end of the symbol as post-fix, where d is the spectrum extension factor. This results in an OFDM symbol of size M+d, which can be represented as,

$${X}_{e x s} ( k ) = X ( ( k - \frac{d}{2} ) mod M )$$

where, k=0, 1, . . . , M+d−1. In an embodiment, the excess bandwidth (or excess subcarriers) used may be arbitrarily high and may be more than M subcarriers.

In an embodiment, a transmitter which is a base station or gNB may indicate a user with 2 parameters i.e. usable BW where data is allocated, and excess BW where shaping is allowed. A scheduler of the gNB may take care of these 2 parameters per UE as part of the entire scheduling operations. The excess BW when symmetric can be assumed to have equal guard subcarriers on either side of the allocated spectrum. However, for asymmetric cases, an additional parameter which indicates the start location of the usable BW can be indicated between UE and gNB. The spectrum extension factor depends on channel properties, allocation size, modulation order, coding rate, and RS, CP lengths. Pi/2-BPSK modulation is a special case, where spectrum extension may not be needed. Spectrum shaping is performed on the spectrum extended data by multiplying with the frequency response of the spectrum shaping filter. The spectrum shaped data can be given by,

$$i . {X}_{s s} ( k ) = W ( k ) {X}_{e x s} ( k )$$

where W(k) is a filter, which is a frequency response of square root raise cosine, raised cosine, Hanning, Blackman or Hamming windows, or the filter can be an oversampled Linearized Gaussian Minimal Shifting Keying (LGMSK) pulse. Otherwise, filter W(k) may be a square root of the frequency response of the above-mentioned filters. The spectrum shaping filter either be specified by the base station or can be unknown at the base station. The spectrum shaping filter may be RANI specified or specification transparent.

When spectrum extension factor ‘d’ is zero, no spectrum extension is performed, for example modulation schemes like pi/2-BPSK. In this case, spectrum shaping can be performed either in time-domain by circular convolving the data-RS multiplexed symbol with impulse response of the spectrum shaping filter or in frequency domain, where the DFT-pre-coded symbol is simply multiplied with the frequency response of the spectrum shaping filter. The spectrum shaping help in reduction of PAPR, which eventually results in better power efficiency.

One embodiment of the present disclosure is a receiver. At the receiver, the received signal is first processed with front processing elements like ADC, CP removal and FFT. The allocated sub-carriers are de-mapped in the sub-carrier de-mapper, where M+d allocated sub-carriers are de-mapped from entire FFT output. If spectrum shaping performed at the transmitter is with square root of the frequency response of the spectrum shaping filter and filter is known at the receiver, then de-mapped “M+d” subcarriers are multiplied with the same filter used at the transmitter before further processing. This helps in maximizing the receiver SNR. If the filter is not known at the receiver, then the de-mapped data is processed without any receiver shaping. The filter used at the receiver can be called as subcarrier filters. Each of the subcarrier filters is one of SQRC, RC, Hanning, Hamming, Blackman, or LGMSK pulses, or square root of these pulses.

The slot which has 14 OFDM symbols may contain at least one or 2 OFDM symbols of the proposed pre-DFT RS and spreaded control/data multiplexed DFT-s-OFDM with excess bandwidth shaping. When the number of symbols allocated with the proposed system is more than one OFDM symbol, the long RS may be presented in one of the OFDM symbols that may be front loaded. Short RS or PTRS may be present in other symbols including the symbol with long RS. Channel estimation is performed on the symbol with long RS, and the small RS chunks or PTRS can be used for phase tracking. This way RS density can be low and the latency can be from at least 1 to at max allocated number of OFDM symbols.

In the following embodiments a method of design of spreading sequences that can be used as RS or for the purpose of spreading control or data is provided.

In this method a base sequence that is obtained by taking a BPSK sequence that goes through pi/2 constellation rotation. Various cyclic shifts of the base sequence may be used as inputs. The base sequences and the number of cyclic shifts that result in low PAPR and low correlation among the base sequences and zero correlation among the cyclic shifts of a base sequence may be obtained through a computer search. The base sequences are optimized such that the generated waveforms have optimized or low PARP.

In an embodiment of the present disclosure, a method for transmitting an OTFDM waveform with circular transmit diversity is disclosed. The method comprising time-multiplexing, by a communication system, at least one data sequence with at least one RS, to generate a multiplexed sequence. Also, the method comprising obtaining, by the communication system, a plurality of circularly shifted sequences using the multiplexed sequence, each of the plurality of circularly shifted sequences is obtained by circularly shifting the multiplexed sequence by a predefined number of samples or multiples of predefined number of samples. Further, the method comprises generating, by the communication system, an OTFDM symbol corresponding to each of the plurality of circularly shifted sequences and transmitting an OTFDM waveform, by mapping the generated OTFDM symbols to the corresponding antenna ports of the communication system.

In another embodiment of the present disclosure, a method for transmitting an OTFDM waveform with circular transmit diversity is disclosed. The method comprising generating, by a communication system, at least one data sequence and a plurality of reference sequences (RS). Also, the method comprises obtaining, by the communication system, a plurality of circularly shifted data sequences using the at least one data sequence, each of the plurality of circularly shifted data sequences is obtained by circularly shifting the at least one data sequence by a predefined number of samples or multiples of predefined number of samples. Further, the method comprises time-multiplexing, by the communication system, each of the plurality of circularly shifted data sequences with one of the plurality of RS to obtain a plurality of multiplexed sequences. Thereafter, the method comprises generating, by the communication system, an OTFDM symbol corresponding to each of the plurality of multiplexed sequences, and transmitting an OTFDM waveform, by mapping the generated OTFDM symbols to the corresponding antenna ports of the communication system.

A description of an embodiment with several components in communication with each other does not imply that all such components are required. On the contrary a variety of optional components are described to illustrate the wide variety of possible embodiments of the invention.

When a single device or article is described herein, it will be clear that more than one device/article (whether they cooperate) may be used in place of a single device/article. Similarly, where more than one device or article is described herein (whether they cooperate), it will be clear that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

Finally, the language used in the specification has been principally selected for readability and instructional purposes, and it may not have been selected to delineate or circumscribe the inventive subject matter. It is therefore intended that the scope of the invention be limited not by this detailed description. Accordingly, the disclosure of the embodiments of the invention is intended to be illustrative, but not limiting, of the scope of the invention.

While various aspects and embodiments have been disclosed herein, other aspects and embodiments will be apparent to those skilled in the art. The various aspects and embodiments disclosed herein are for purposes of illustration and are not intended to be limiting.

What is claimed is:

1. A method for transmitting an OTFDM waveform with circular transmit diversity, comprising:
time-multiplexing, by a communication system, at least one data sequence with at least one RS, to generate a multiplexed sequence;
obtaining, by the communication system, a plurality of circularly shifted sequences using the multiplexed sequence, each of the plurality of circularly shifted sequences is obtained by circularly shifting the multiplexed sequence by a predefined number of samples or multiples of predefined number of samples;
generating, by the communication system, an OTFDM symbol corresponding to each of the plurality of circularly shifted sequences; and
transmitting, by the communication system, an OTFDM waveform, by mapping the generated OTFDM symbols to the corresponding antenna ports of the communication system.

2. The method as claimed in claim 1, wherein the at least one data sequence is one of a pi/2 binary phase shift keying (pi/2-BPSK) sequence, a BPSK sequence, a Quadrature Phase Shift Keying (QPSK) sequence, M-ary Quadrature Amplitude Modulation (QAM) sequence, and an M-ary Phase Shift Keying (PSK) sequence.

3. The method as claimed in claim 1, wherein the at least one data sequence comprises at least one of a user data, a control information, system information, and paging messages, said user data, said control information, said system information, and said paging messages is a modulated alphabet or sequences of modulated alphabets.

4. The method as claimed in claim 1, wherein a spreading operation is performed on the at least one data sequence with a spread code to generate a spread data sequence.

5. The method as claimed in claim 1, wherein a spreading operation is performed on each of the plurality of multiplexed sequences with a corresponding spread code to generate a spread multiplexed sequence.

6. The method as claimed in claim 1, wherein the at least one data sequence is appended with a data cyclic prefix (CP).

7. The method as claimed in claim 1, wherein the at least one data sequence comprises a user data and at least one phase tracking reference sequence (PTRS).

8. The method as claimed in claim 1, wherein each of the plurality of circularly shifted sequences is appended with at least one of a corresponding CP and a corresponding CS.

9. The method as claimed in claim 1, wherein the at least one RS is one of a pi/2 binary phase shift keying (pi/2-BPSK) sequence, a BPSK sequence, a Zadoff-Chu (ZC) sequence, a Quadrature Phase Shift Keying (QPSK) sequence, and a M-ary Phase Shift Keying (PSK) sequence.

10. The method as claimed in claim 1, wherein the at least one RS is appended with at least one of a cyclic prefix (CP) and a cyclic suffix (CS).

11. The method as claimed in claim 1, wherein the predefined number of samples depends on at least one of a cell size, a modulation index, and antenna ports.

12. The method as claimed in claim 1, wherein generating the plurality of OTFDM symbols comprising:
transforming the plurality of circularly shifted sequences using a Discrete Fourier Transform (DFT) to generate a plurality of transformed sequences;
performing padding operation by prefixing each of the plurality of transformed sequences with a first predefined number (N1) of subcarriers and post-fixing each of the plurality of transformed sequences with a second predefined number (N2) of subcarriers to obtain corresponding plurality of extended bandwidth transformed sequences;
mapping each of the plurality of extended bandwidth transformed sequences with at least one of localized and distributed subcarriers to generate a plurality of mapped sequences;
shaping each of the plurality of mapped sequences using a filter to obtain a plurality of shaped sequences;
performing an Inverse Fast Fourier Transform (IFFT) on each of the plurality of shaped sequences to produce a plurality of time domain sequences; and
processing the plurality of time domain sequences to generate a plurality of OTFDM waveforms.

13. The method as claimed in claim 12, wherein value of the N1 is at least zero, and value of the N2 is at least zero.

14. The method as claimed in claim 12, wherein processing the plurality of time domain sequences to generate the plurality of OTFDM waveforms comprises performing at least one of addition of symbol cyclic prefix, addition of symbol cyclic suffix, windowing, weighted with overlap and add operation (WOLA), bandwidth parts (BWP) rotation, additional time domain filtering, sampling rate conversion to match DAC rate, frequency shifting and digital to analog conversion on the plurality of time domain sequences, to generate the plurality of OTFDM waveforms.

15. The method as claimed in claim 12, wherein the filter used for shaping each of the plurality of mapped sequences is one of a Nyquist filter, square root raised cosine filter, a raised cosine filter, a hamming filter, a Hanning filter, a Kaiser filter, an oversampled GMSK filter, a truncated version of Nyquist filter, a truncated version of square root raised cosine filter, a truncated version of raised cosine filter, a truncated version of hamming filter, a truncated version of Hanning filter, a truncated version of Kaiser filter, and a truncated version of an oversampled GMSK filter.

16. A method for transmitting an OTFDM waveform with circular transmit diversity, comprising:
generating, by a communication system, at least one data sequence and a plurality of reference sequences (RS);
obtaining, by the communication system, a plurality of circularly shifted data sequences using the at least one data sequence, each of the plurality of circularly shifted data sequences is obtained by circularly shifting the at least one data sequence by a predefined number of samples or multiples of predefined number of samples;
time-multiplexing, by the communication system, each of the plurality of circularly shifted data sequences with one of the plurality of RS to obtain a plurality of multiplexed sequences; and
generating, by the communication system, an OTFDM symbol corresponding to each of the plurality of multiplexed sequences; and
transmitting, by the communication system, an OTFDM waveform, by mapping the generated OTFDM symbols to the corresponding antenna ports of the communication system.

17. The method as claimed in claim 16, wherein the at least one data sequence is one of a pi/2 binary phase shift keying (pi/2-BPSK) sequence, a BPSK sequence, a Quadrature Phase Shift Keying (QPSK) sequence, M-ary Quadrature Amplitude Modulation (QAM) sequence, and an M-ary Phase Shift Keying (PSK) sequence.

18. The method as claimed in claim 16, wherein the at least one data sequence comprises at least one of a user data, a control information, system information, and paging messages, said user data, said control information, said system information, and said paging messages is a modulated alphabet or sequences of modulated alphabets.

19. The method as claimed in claim 16, wherein a spreading operation is performed on the at least one data sequence with a spread code to generate a spread data sequence.

20. The method as claimed in claim 16, wherein a spreading operation is performed on each of the plurality of multiplexed sequences with a corresponding spread code to generate a spread multiplexed sequence.

21-39. (canceled)
